(19) United States
(12) Patent Application Publication
(10) Pub. No.: US 2025/0139933 A1
(43) Pub. Date: May 1, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Taku SATO, Osaka (JP)

(21) Appl. No.: 18/915,426

(22) Filed: Oct. 15, 2024

(30) Foreign Application Priority Data
Nov. 1, 2023 (JP) 2023-187900

(51) Int. Cl. G06V 10/44; G06V 40/16

(52) U.S. Cl. CPC G06V 10/44; G06V 40/161

(57) ABSTRACT

An information processing apparatus comprises an acquisition unit configured to acquire input data, and an application unit configured to obtain an attention vector by performing a feature transformation process having a local receptive field on the input data, and apply attention to the input data based on the input data and the attention vector.

### BACKGROUND OF THE INVENTION

### Field of the Invention

The present invention relates to an information processing technique.

### Description of the Related Art

In each layer of known convolutional neural networks (CNN), feature extraction is performed using a fixed weight. On the other hand, an attention mechanism that dynamically adjusts weight at the time of feature extraction according to an input has been proposed. For example, there is a method of obtaining an importance degree for each feature channel and adjusting the gain of the feature channel. An important channel is calculated after the dimensional compression in the spatial direction is performed (Hu, Jie, Li Shen, and Gang Sun. “Squeeze-and-excitation networks.” Proceedings of the IEEE Conference on Computer vision and Pattern Recognition. 2018.). In addition, for example, there is a self-attention mechanism that divides input data into a plurality of regions, checks the degree of relevance between the regions, and determines which feature of which element is extracted based on the degree of relevance (Japanese Patent No. 06884871). Furthermore, for example, there is a method of performing an attention process only with some region pairs without processing combinations of all regions in self-attention (Dong, Xiaoyi, et al. “Cswin transformer: A general vision transformer backbone with cross-shaped windows.” Proceedings of the IEEE/CVF Conference on Computer Vision and Pattern Recognition. 2022.).

In the method of Japanese Patent No. 06884871, since the relationship among all the regions is obtained, a matrix shape transformation process having a high processing cost regarding the amount of calculation and the number of parameters and a high calculation cost on hardware is included. On the other hand, in the method of Hu, Jie, Li Shen, and Gang Sun. “Squeeze-and-excitation networks.” Proceedings of the IEEE Conference on Computer vision and Pattern Recognition. 2018., the coefficient of attention is calculated at a low cost by compressing and reducing the input data in the spatial direction. In addition, in the method of Dong, Xiaoyi, et al. “Cswin transformer: A general vision transformer backbone with cross-shaped windows.” Proceedings of the IEEE/CVF Conference on Computer Vision and Pattern Recognition. 2022., the processing amount is reduced by limiting the combination of the regions. Such a reduction increases the efficiency of the attention process. However, there is a case where extraction of a complex relationship across a plurality of regions and a plurality of feature dimensions leaks and inference accuracy deteriorates. Thus, there is a trade-off relationship between the processing amount of attention and the inference accuracy.

### SUMMARY OF THE INVENTION

The present invention provides a technique for realizing an attention mechanism by a feature transformation process having a local receptive field of an appropriate size.

According to the first aspect of the present disclosure, there is provided an information processing apparatus comprising: an acquisition unit configured to acquire input data; and an application unit configured to obtain an attention vector by performing a feature transformation process having a local receptive field on the input data, and apply attention to the input data based on the input data and the attention vector.

According to the second aspect of the present disclosure, there is provided an information processing method performed by an information processing apparatus, the method comprising: acquiring input data; obtaining an attention vector by performing feature transformation process having a local receptive field on the input data, and applying attention to the input data based on the input data and the attention vector.

According to the third aspect of the present disclosure, there is provided a non-transitory computer-readable storage medium storing a computer program for causing a computer to function as: an acquisition unit configured to acquire input data; and an application unit configured to obtain an attention vector by performing a feature transformation process having a local receptive field on the input data, and apply attention to the input data based on the input data and the attention vector.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration example of a computer device applicable to an information processing apparatus.

FIG. 2 is a block diagram illustrating a functional configuration example of the information processing apparatus.

FIG. 3 illustrates a configuration example of a feature transformation processing unit 300.

FIG. 4 is a block diagram illustrating an application example of the feature transformation processing unit 300.

FIG. 5 is a diagram for describing an effect of feature transformation process having a local receptive field;

FIG. 6 is a block diagram illustrating an application example of the feature transformation processing unit 300.

FIG. 7 is a diagram describing an effect of repeating a feature transformation process having a local receptive field a plurality of times.

FIG. 8 is a block diagram illustrating an application example of the feature transformation processing unit 300.

FIG. 9 is a flowchart illustrating an operation of the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

First, a functional configuration example of an information processing apparatus according to the present embodiment functioning as an inference device will be described with reference to a block diagram of FIG. 2. In the present embodiment, a case will be described in which a face authentication task for determining whether a face of a person included in one image and a face of a person included in the other image are faces of the same person is performed, but the following description is similarly applicable to other types of tasks.

An acquisition unit 201 acquires an image including a face of a person as an input image. Note that the acquisition unit 201 may extract a region of the face from the image including the face of the person and acquire the image (face image) in the extracted region as the input image. Note that the method of acquiring an input image by the acquisition unit 201 is not limited to a specific acquisition method, and an input image stored in a memory in the information processing apparatus may be acquired, or an input image held in an external device or an input image transmitted from the external device may be acquired.

An arithmetic unit 202 inputs the input image acquired by the acquisition unit 201 to a neural network, performs arithmetic process of the neural network, and calculates a feature vector (face feature vector) of the face of the person included in the input image. For example, Convolutional Neural Networks (CNN) can be used as the neural network for calculating the face feature vector. For CNN, ResNet or the like introduced in K. He, X. Zhang, S. Ren, and J. Sun. Identity mappings in deep residual networks. In ECCV, 2016 or the like may be used, or a neural network described in Alexey Dosovitskiy, et al. An image is worth 16×16 words: Transformers for image recognition at scale. In ICLR, 2021., known as Vision Transformer (ViT), may be used. The configuration of the neural network applicable to the present embodiment is not limited thereto, but has a structure of interiorly including an attention mechanism described later.

A collation unit 203 collates a first face feature vector calculated by the arithmetic unit 202 for one input image acquired by the acquisition unit 201 with a second face feature vector calculated by the arithmetic unit 202 for the other input image acquired by the acquisition unit 201. Then, when the similarity between the first face feature vector and the second face feature vector is within a threshold value, the collation unit 203 performs face authentication to determine that the face corresponding to the first face feature vector and the face corresponding to the second face feature vector are faces of the same person. Note that the method of face authentication using the first face feature vector and the second face feature vector is not limited to a specific method.

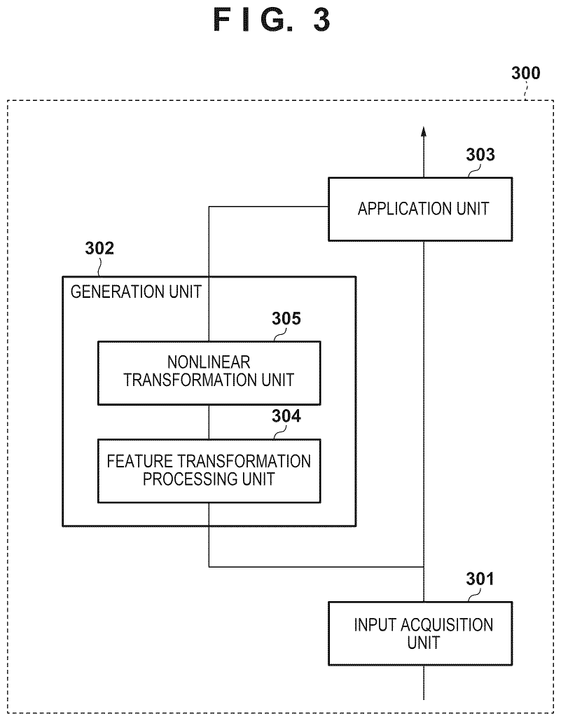

Next, a configuration example of the feature transformation processing unit 300 applicable to the neural network used in the arithmetic unit 202 will be described with reference to the block diagram of FIG. 3. In particular, unlike a processing unit in an ordinary CNN, the feature transformation processing unit 300 includes an attention mechanism that obtains a relationship between elements of input data and performs feature extraction from the input data based on the relationship.

An input acquisition unit 301 acquires, as input data, the input image acquired by the acquisition unit 201 or the face feature vector transformed into a vector through pre-process. Note that the input acquisition unit 301 may normalize the input image or the face feature vector.

A generation unit 302 includes a feature transformation processing unit 304 having a local receptive field and a nonlinear transformation unit 305 that performs nonlinear transformation. The feature transformation processing unit 304 performs a “feature transformation process having a local receptive field” on the input data acquired by the input acquisition unit 301 to acquire, as an attention vector, a “vector having the same number of dimensions as the input data and in which each element has an individual value”. Details of the “feature transformation process having a local receptive field” will be described later. Note that a plurality of processes may be repeated or different processes may be combined for the “feature transformation process having a local receptive field”.

The nonlinear transformation unit 305 performs nonlinear transformation using an activation function such as ReLU or PReLU on the attention vector that is the processing result of the feature transformation processing unit 304. This has an effect of reducing unnecessary information and enhancing expressiveness by nonlinear transformation. Note that the activation function is not limited thereto.

An application unit 303 calculates an element product of the attention vector generated by the generation unit 302 (the attention vector to which the nonlinear transformation is applied by the nonlinear transformation unit 305) and the input data acquired by the input acquisition unit 301. Thus, the application unit 303 acquires the result of the element product as a “result of applying attention to the input data”. Note that, in a case where the above-described feature transformation processing unit 300 has a learning parameter, learning is performed simultaneously with other portions of the neural network to be applied, and the parameter is obtained.

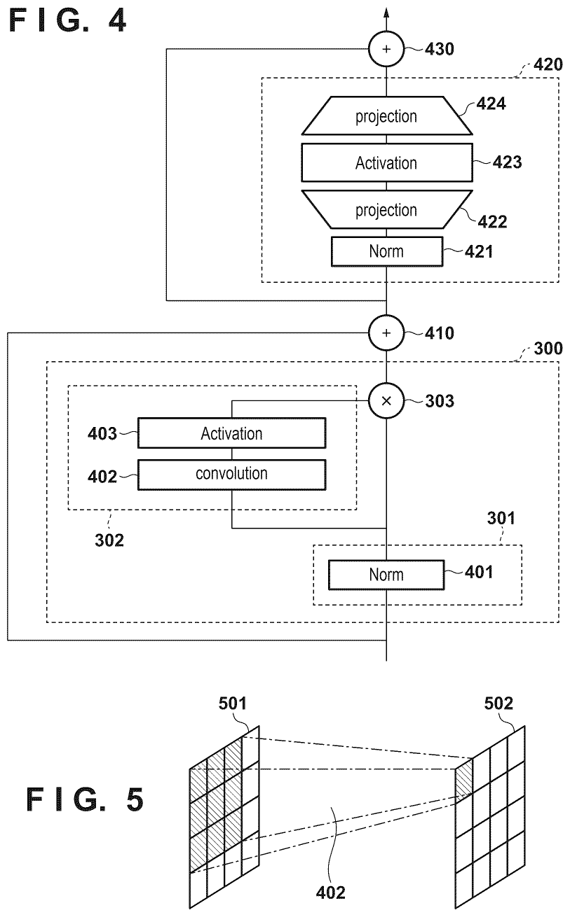

Next, an application example of the above-described feature transformation processing unit 300 is illustrated in a block diagram of FIG. 4. In the application example illustrated in FIG. 4, “the feature transformation processing unit 300 corresponding to the first-half process in the neural network”, “the residual combining unit 410”, “the processing unit 420 corresponding to the second-half process in the neural network”, and “the residual combining unit 430” operate in this order in the arithmetic unit 202.

The input acquisition unit 301 performs normalization process (Norm 401) on the acquired input data. For the normalization process, for example, Batch Normalization described in S. Ioffe and C. Szegedy, Batch normalization: Accelerating deep network training by reducing internal covariate shift. In ICML, 2015 can be applied. Furthermore, for example, Layer Normalization described in Jimmy Lei Ba, Jamie Ryan Kiros, and Geoffrey E Hinton. Layer normalization. arXiv preprint arXiv: 1607.06450, 2016 can be applied to the normalization process for the input data. Note that the normalization process of the input data is not limited to the above process.

The feature transformation processing unit 304 calculates an attention vector by applying convolution process (convolution 402) corresponding to “the feature transformation process having a local receptive field” to the input data normalized by the Norm 401.

Note that the “feature transformation process having a local receptive field” may be convolution, point wise convolution, depth wise convolution, group convolution, or the like. In addition, the “feature transformation process having a local receptive field” is not limited to convolution, and may be max pooling, average pooling, or the like. Furthermore, the “feature transformation process having a local receptive field” may be batch normalization, layer normalization, or the like. Furthermore, the “feature transformation process having a local receptive field” may include one or more of these. Note that the “feature transformation process having a local receptive field” is not limited thereto. Instead of comparing all the elements as in self-attention described in Japanese Patent No. 06884871, feature transformation process is performed with an appropriate receptive field size according to the type of recognition task and the constraints of calculation resources.

Then, the nonlinear transformation unit 305 performs nonlinear transformation (Activation 403) using an activation function such as ReLU or PRELU on the attention vector. Then, the residual combining unit 410 adds “input data”, which is data before and after applying the process of the feature transformation processing unit 300, and “result of an element product of the attention vector and the input data by the application unit 303”.

The processing unit 420 corresponding to the process of the second-half portion subsequent to the process of the feature transformation processing unit 300 includes Norm 421, projection 422, Activation 423, and projection 424.

In the Norm 421, the arithmetic unit 202 normalizes a result of addition by the residual combining unit 410 and acquires the result of the normalization as a feature amount. In the projection 422, the arithmetic unit 202 transforms the feature amount acquired in the Norm 421 by linear transformation to expand the number of dimensions of the feature amount in the channel direction. For example, the arithmetic unit 202 multiplies the number of dimensions of the channel in the feature amount by four by full combining connection. Note that the method of expansion and the magnification of the number of dimensions of the channel are not limited thereto.

In the activation 423, the arithmetic unit 202 applies the activation function to the feature amount transformed by the projection 422. Known ReLU, PRELU, or the like is used for the activation function.

In the projection 424, the arithmetic unit 202 linearly transforms the feature amount to which the activation function is applied in the Activation 423, and reduces the number of dimensions of the feature amount in the channel direction (returns to the original number of dimensions).

The residual combining unit 430 adds “the result of addition by the residual combining unit 410” and “the result of linear transformation by the projection 424”, which are data before and after the above process in the processing unit 420 is applied. The above-described neural network acquires a parameter by learning.

Next, the effect of the feature transformation process having a local receptive field will be described in detail with reference to FIG. 5. FIG. 5 illustrates a state in which convolution with a kernel size of 3×3 is applied to a feature amount 501 with a size of vertical x horizontal of 4×4 to generate a feature amount 502 with the same size. This convolution corresponds to the convolution 402 in FIG. 4. Furthermore, in order to simplify the description, illustration of a padding process for not changing the number of dimensions in the channel direction and the size of the feature amount is omitted. Although not illustrated, as the attention vector, “a vector having the same number of dimensions as the input data and each element having an individual value” is to be generated.

In this example, in order to calculate an element of one shaded portion of the feature amount 502, the element of the shaded portion of 3×3 of the feature amount 501 is referred to. This corresponds to an area of 56% (= 9/16) of the feature amount 501. This is normal convolution process, but in a case where such process is used as the attention generation method, a relationship with a peripheral region of half or more of the whole can be calculated for each element of the feature amount and transformation of the original feature amount can be performed based on the relationship. More specifically, for example, in the face authentication task, in order to transform the feature amount corresponding to the nose, a relationship with a peripheral region occupying half or more of the face such as the eyes and the mouth can be calculated, and the feature transformation of the nose can be performed based on the relationship. Note that the size of the feature amount and the kernel size are not limited thereto. The size of a receptive field is appropriately adjusted by a recognition task. For example, between a case where it is desired to recognize a baseball glove and a case where it is desired to recognize baseball, a larger receptive field is used in a case where it is desired to recognize baseball. This is because various things at distant places in the image, such as batters, pitchers, balls, spectators, the defense, benches, and the like, need to be determined in a complex manner.

As described above, even in the feature transformation process having a local receptive field, it is possible to calculate the relationship between elements in a wide range depending on the size of the feature amount and the kernel size. As a result, accuracy is improved as compared with a case where the importance degree is calculated after the input data is compressed as in, for example, the method of Hu, Jie, Li Shen, and Gang Sun. “Squeeze-and-excitation networks.” Proceedings of the IEEE Conference on Computer vision and Pattern Recognition. 2018. At the same time, the feature transformation process having a local receptive field can reduce the amount of calculation and the number of parameters as compared with the case where the relationship is calculated for the entire region in the spatial direction as in ViT. As described above, both the accuracy and efficiency of the process of the neural network can be achieved.

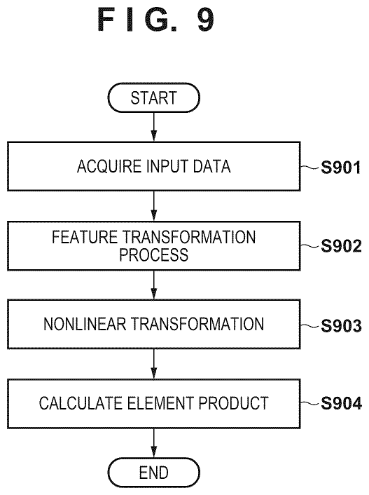

The operation of the information processing apparatus according to the present embodiment will be described with reference to the flowchart of FIG. 9. In step S901, the input acquisition unit 301 acquires input data. In step S902, the feature transformation processing unit 304 acquires an attention vector by performing a “feature transformation process having a local receptive field” on the input data.

In step S903, the nonlinear transformation unit 305 performs nonlinear transformation using an activation function on the attention vector. In step S904, the application unit 303 calculates the element product of the attention vector and the input data.

Although description has been made above targeting on the face authentication task, the feature transformation process according to the present embodiment may be applied to neural networks for various tasks. For example, the present invention may be applied to a neural network of image classification, object detection, scene recognition, semantic segmentation, or the like. In addition, not limited to the device for the face authentication task, an appropriate device may be used for each task.

### Second Embodiment

In the following embodiments including the present embodiment, difference from the first embodiment will be described, assuming that the following embodiments are similar to the first embodiment unless otherwise specified. In the first embodiment, an example has been described in which the feature transformation process having a local receptive field is applied only once when generating the attention vector. However, the feature transformation process having a local receptive field may be performed twice or more. In the present embodiment, a case where feature transformation process having a local receptive field is applied a plurality of times will be described.

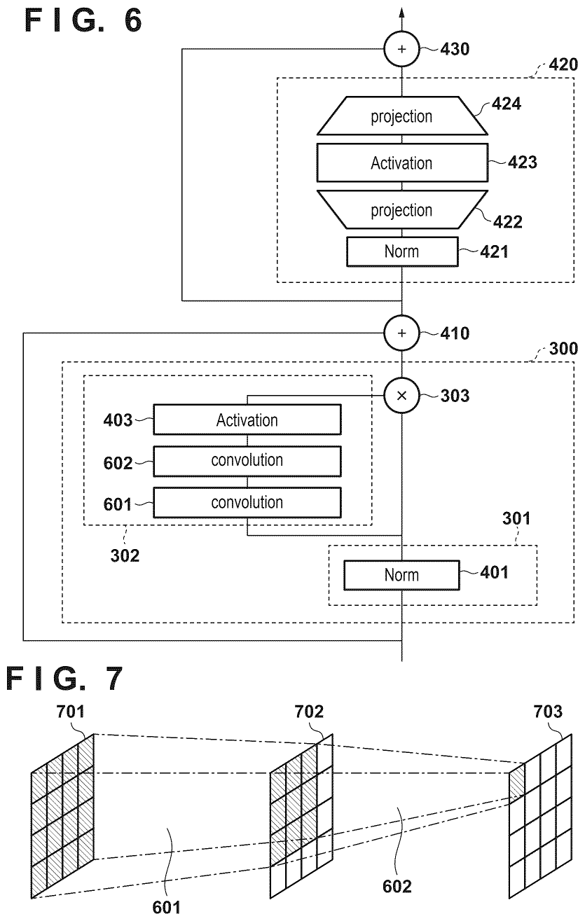

An application example of the feature transformation processing unit 300 is illustrated in a block diagram of FIG. 6. In FIG. 6, the same processes as those illustrated in FIG. 4 are denoted by the same reference numerals, and description of the processes will be omitted. In FIG. 6, a convolution 601 and a convolution 602 are provided instead of the convolution 402 of FIG. 4, and the convolution process is applied twice on the input data normalized by the Norm 401. Note that, similarly to the convolution 402, various convolutions described in the first embodiment can be applied to the convolution 601 and the convolution 602. In addition, since both the convolution 601 and the convolution 602 are examples of the “feature transformation process having a local receptive field”, in the present embodiment, the convolution is not limited to being applied twice, and one or both of them may be the process other than the convolution. The “process other than convolution” may be, for example, max pooling, average pooling, or the like as described in the first embodiment, or may be batch normalization, layer normalization, or the like.

Here, an effect of repeating the feature transformation process having a local receptive field a plurality of times will be described with reference to FIG. 7. FIG. 7 illustrates a state in which convolution having a kernel size of 3×3 is applied twice to the feature amount 701 having a size of 4×4 in height×width, for example, to generate the feature amount 703 having the same size. In FIG. 7, a convolution having a kernel size of 3×3 is applied once to the feature amount 701 to generate the feature amount 702 having the same size, and a convolution having a kernel size of 3×3 is applied once to the feature amount 702 to generate the feature amount 703 having the same size. Furthermore, in order to simplify the description, illustration of a padding process for not changing the number of dimensions in the channel direction and the size of the feature amount is omitted.

FIG. 7 illustrates that the element of the shaded portion of 3×3 of the feature amount 702 is referred to in order to calculate the element of one shaded portion of the feature amount 703, and the element of the shaded portion (entire region) of the feature amount 701 is referred to in order to calculate the element of the shaded portion of 3×3 of the feature amount 702. That is, it means that the entire region of the original feature amount 701 is referred to in order to calculate one element of the feature amount 703. In a case where such process is used as the attention generation method, the relationship with the entire region is calculated for each element of the feature amount and the transformation of the original feature amount can be performed based on the relationship. Note that the combination of the number of times the feature transformation process having a local receptive field is repeated, the size of the feature amount, the kernel size, and the process is not limited thereto.

As described above, when the feature transformation process having a local receptive field is repeated a plurality of times, a region that can be indirectly referred to when generating the attention vector is widened, and a wider range of relationship can be calculated. Here, by widening the range to be referred to in a stepwise manner, an increase in the amount of calculation and the number of parameters can be suppressed as compared with a case of performing calculation at one time. From the above, it is possible to achieve both accuracy and efficiency of process in the neural network.

The convolution in which the weight of the neural network is shared in the spatial direction has been described so far as an example. However, depending on the feature map size, a process having an individual weight for each position may be applied without sharing weights.

### Third Embodiment

In the first and second embodiments, a case where normal convolution is applied to the generation unit 302 has been described. In this case, the relationship between wider regions can be calculated by increasing the kernel size or the number of repetitions of the convolution applied to the generation unit 302. However, in the normal convolution, the amount of calculation and the number of parameters increase in proportion to the square of the kernel size. Therefore, for example, MobileNet described in Howard, Andrew, et al. “Searching for mobilenetv 3.” Proceedings of the IEEE/CVF international conference on computer vision. 2019 proposes a method of temporarily increasing the number of channel dimensions instead of dividing the convolution calculation into a process only in the channel direction and a process only in the spatial direction. The MobileNet is lighter than a network using only normal convolution. In the present embodiment, a case will be described in which a feature transformation process in which the number of channel dimensions changes in the middle as in the above-described MobileNet is applied.

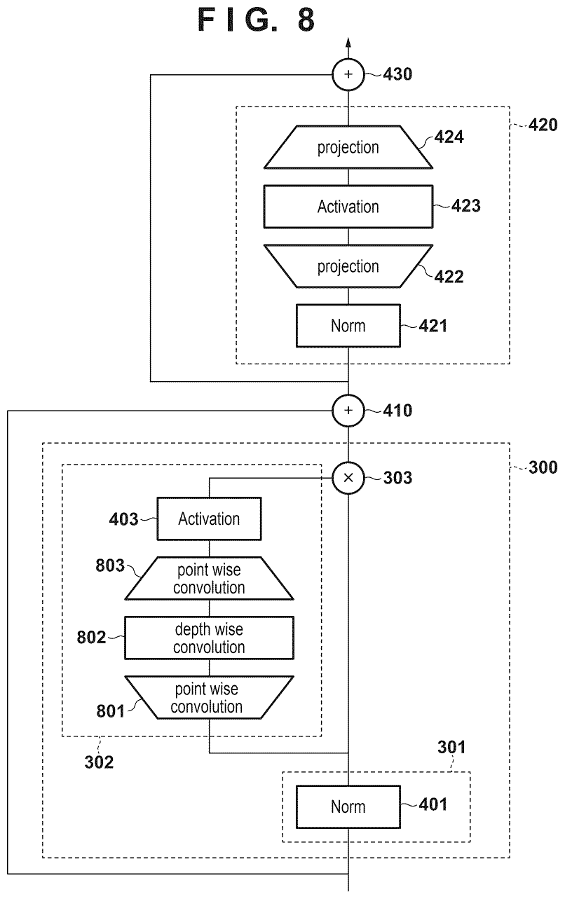

An application example of the feature transformation processing unit 300 is illustrated in a block diagram of FIG. 8. In FIG. 8, the same processes as those illustrated in FIG. 4 are denoted by the same reference numerals, and description of the processes will be omitted.

The feature transformation processing unit 304 applies point wise convolution 801 on the input data normalized by the Norm 401 to increase the number of channel dimensions of the input data (e.g., to triple the number of channel dimensions).

Next, the feature transformation processing unit 304 applies a depth wise convolution 802 to the input data in which the number of channel dimensions has been increased by the point wise convolution 801 (here, the number of channel dimensions does not change).

Next, the feature transformation processing unit 304 applies a point wise convolution 803 to the input data obtained by applying the depth wise convolution 802, and returns the number of channel dimensions of the input data to the original number of channel dimensions. For example, the feature transformation processing unit 304 applies the point wise convolution 803 to set the number of channel dimensions of the input data to one third, and decreases it by the amount increased by the point wise convolution 801. Note that, as long as the attention vector having the same number of dimensions as the input data and each element having an individual value can be finally generated, the number of dimensions may change in the middle, and this is not limited to MobileNet.

As described above, an increase in the amount of calculation and the number of parameters can be suppressed even if the kernel size and the number of repetitions of process are increased by applying MobileNet to the present embodiment. As described above, both the accuracy and efficiency of the process of the neural network can be achieved.

### Fourth Embodiment

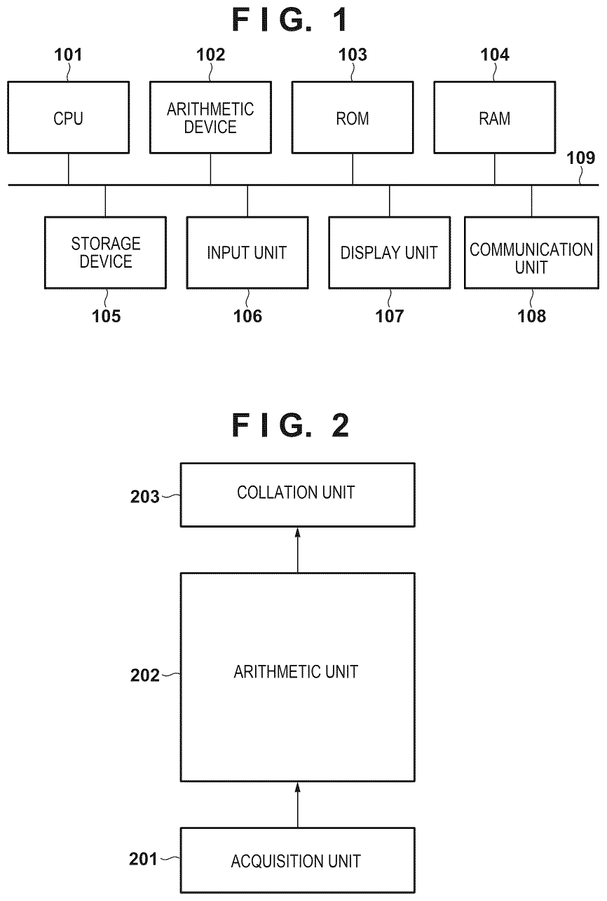

The functional units illustrated in FIG. 2 may be implemented by hardware, or may be implemented by software (computer program). In the latter case, the computer device that can execute the software is applicable to the information processing apparatus according to the first to third embodiments. A hardware configuration example of a computer device applicable to an information processing apparatus according to the first to third embodiments will be described with reference to a block diagram of FIG. 1.

A CPU 101 executes various processes using computer programs and data stored in a RAM 104. As a result, the CPU 101 controls the operation of the entire computer device, and executes or controls various processes described as the processes performed by the information processing apparatus according to the first to third embodiments.

The arithmetic device 102 is a device including a GPU and/or other calculation processing circuits, and for example, executes functions corresponding to the arithmetic unit 202 and the collation unit 203 under the control of the CPU 101.

In the ROM 103, setting data of the computer device, computer programs and data related to activation of the computer device, computer programs and data related to basic operations of the computer device, or the like are stored.

The RAM 104 includes an area for storing computer programs and data loaded from the ROM 103 or the storage device 105, and an area for storing computer programs and data received from the outside via a communication unit 108. Furthermore, the RAM 104 has a work area used when the CPU 101 or the arithmetic device 102 executes various processes. The RAM 104 may thus provide various areas as appropriate.

The storage device 105 is a large-capacity information storage device such as a hard disk drive. The storage device 105 stores an OS, computer programs, data, and the like for causing the CPU 101 and the arithmetic device 102 to execute or control various processes described as processes performed by the information processing apparatus according to the first to third embodiments. The data stored in the storage device 105 also includes parameters such as weights of the neural network.

Note that the storage device 105 may include a memory card, an optical disk such as a flexible disk (FD) or a compact disc (CD) attachable and detachable with respect to a computer device, a magnetic or optical card, an IC card, a memory card, and the like.

The input unit 106 is a “device for inputting information to a computer device” such as a keyboard, a mouse, a touch panel, a dial, and a sensor. For example, in a case where the input unit 106 is an imaging device, the computer device can acquire an “image including a face of a person” captured by the imaging device.

The display unit 107 is a device having a liquid crystal screen or a touch panel screen, and can display a processing result by the CPU 101 or the arithmetic device 102 with an image, a character, or the like. Note that the display unit 107 may be a projection device such as a projector that projects images or characters.

The communication unit 108 is a communication interface for communicating with the outside via a network such as a LAN or the Internet. For example, the computer device can acquire an “image including a face of a person” from the outside via the communication unit 108.

The CPU 101, the arithmetic device 102, the ROM 103, the RAM 104, the storage device 105, the input unit 106, the display unit 107, and the communication unit 108 are all connected to the system bus 109. Note that the hardware configuration of the computer device applicable to the information processing apparatus according to the first to third embodiments is not limited to the configuration illustrated in FIG. 1, and can be modified/changed as appropriate.

The numerical values, processing timings, processing orders, processing entities, and data (information) acquiring method/transmission destination/transmission source/storage location, and the like that are used in each of the embodiments described above are referred to by way of an example for specific description, and are not intended to be limited to these examples.

Alternatively, some or all of the embodiments described above may be used in combination as appropriate. Alternatively, some or all of the embodiments described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-187900, filed Nov. 1, 2023, which is hereby incorporated by reference herein in its entirety.

What is claimed is:

1. An information processing apparatus comprising:
an acquisition unit configured to acquire input data; and
an application unit configured to obtain an attention vector by performing a feature transformation process having a local receptive field on the input data, and apply attention to the input data based on the input data and the attention vector.

2. The information processing apparatus according to claim 1, wherein the acquisition unit acquires an image or an image in a region of a face extracted from the image as the input data.

3. The information processing apparatus according to claim 1, wherein the application unit performs the feature transformation process on the input data once or twice or more.

4. The information processing apparatus according to claim 1, wherein
the attention vector is a vector obtained by performing nonlinear transformation by an activation function on a vector obtained as a result of the feature transformation process, and
the application unit obtains an element product of the attention vector and the input data.

5. The information processing apparatus according to claim 1, wherein a parameter of the application unit is acquired by learning.

6. The information processing apparatus according to claim 1, wherein the feature transformation process includes one or more of convolution, point wise convolution, depth wise convolution, group convolution, max pooling, average pooling, batch normalization, and layer normalization.

7. The information processing apparatus according to claim 1, wherein the attention vector is a vector having the same number of dimensions as the input data.

8. The information processing apparatus according to claim 1, further comprising:
a first addition unit configured to add the input data and a result of the application;
a normalization unit configured to normalize the result of the addition and acquire a result of the normalization as a feature amount;
a first transformation unit configured to transform the feature amount by linear transformation to expand the number of dimensions of the feature amount in a channel direction;
an activation unit configured to apply an activation function to the transformed feature amount;
a second transformation unit configured to linearly transform the feature amount to which the activation function is applied and to reduce the number of dimensions of the feature amount in a channel direction; and
a second addition unit configured to add a result of the addition and a result of the linear transformation.

9. An information processing method performed by an information processing apparatus, the method comprising:
acquiring input data;
obtaining an attention vector by performing feature transformation process having a local receptive field on the input data, and applying attention to the input data based on the input data and the attention vector.

10. A non-transitory computer-readable storage medium storing a computer program for causing a computer to function as:
an acquisition unit configured to acquire input data; and
an application unit configured to obtain an attention vector by performing a feature transformation process having a local receptive field on the input data, and apply attention to the input data based on the input data and the attention vector.
